(19) United States
(12) Patent Application Publication
(10) Pub. No.: US 2026/0350140 A1
(43) Pub. Date: Nov. 5, 2026

(54) DATA FUSION METHOD, DEVICES, DATA FUSION SYSTEM, AND STORAGE MEDIUM

(71) Applicant: CLOUD INTELLIGENCE ASSETS HOLDING (SINGAPORE) PRIVATE LIMITED, Singapore (SG)

(72) Inventors: Sheng WANG, Singapore (SG); Huorong LI, Beijing (CN); Yiran LI, Beijing (CN); Le SU, Singapore (SG); Yanshan ZHANG, Singapore (SG); Feifei LI, Hangzhou, Zhejiang (CN)

(73) Assignee: CLOUD INTELLIGENCE ASSETS HOLDING (SINGAPORE) PRIVATE LIMITED, Singapore (SG)

(21) Appl. No.: 19/100,101

(22) PCT Filed: Jul. 31, 2023
(86) PCT No.: PCT/CN2023/110357

§ 371 Date: Jan. 30, 2025

(30) Foreign Application Priority Data
Aug. 1, 2022 (CN) 202210915575.0

(51) Int. Cl. G06F 21/53; G06F 21/62

(52) U.S. Cl. CPC G06F 21/53; G06F 21/6227

(57) ABSTRACT

Provided in the embodiments of the present application are a data fusion method, devices, a data fusion system, and a storage medium. The method comprises: for fusion groups having a requirement, creating dedicated fusion services for the fusion groups in a trusted execution environment (300); acquiring a behavior control rule signed and issued by each participant in the fusion groups; and on this basis, in the trusted execution environment, responding, by using the fusion services and within the range of the behavior control rules, to a fusion calculation request sent out in the fusion groups (302). Accordingly, fusion calculation processes of different fusion groups can be separated from each other on the basis of different fusion services created for the different fusion groups; and the fusion services are completely run in a trusted execution environment, cannot be tampered with, and work according to behavior control rules by default.

### CROSS REFERENCE TO RELATED APPLICATIONS

The present disclosure is a National Stage of International Application PCT/CN2023/110357, filed on Jul. 31, 2023, which claims priority of Chinese Patent Application No. 202210915575.0, filed with the Chinese Patent Office on Aug. 1, 2022, entitled “DATA FUSION METHOD, DEVICES, DATA FUSION SYSTEM, AND STORAGE MEDIUM”, the entire contents of the above mentioned applications are incorporated herein by reference.

### TECHNICAL FIELD

The present disclosure relates to the field of data processing, and in particular, to a data fusion method, devices, data fusion system, and storage medium.

### BACKGROUND

In data fusion technology, physical or logical fusion on data of a plurality of participants may be performed, and data computational analysis may be performed after data fusion to better mine the value of the data.

In the data fusion process, it is necessary to perform computational analysis on data of a plurality of participants, therefore, lack of effective security protection measures possibly leads to the problem of data leakage of the participants and brings losses to the participants.

### SUMMARY

Various aspects of the present disclosure provide a data fusion method, devices, data fusion system, and storage medium, to solve the data leakage problem in a data fusion process.

Examples of the present disclosure provides a data fusion method, including:
for each of one or more fusion groups with a requirement, creating a dedicated fusion service for the fusion group in a trusted execution environment;
obtaining behavior control rules signed and issued by each participant in the fusion group; and
responding, by utilizing the fusion service, to a fusion computation request issued from within the fusion group, within a scope of the behavior control rules in the trusted execution environment.

Examples of the present disclosure further provides a data fusion method, including:
for each of one or more fusion groups with a requirement, triggering a trusted device to create a dedicated fusion service for the fusion group, where the trusted device provides a trusted execution environment for the fusion service;
providing behavior control rules signed and issued by each participant in the fusion group to the trusted device, to limit service permissions for the fusion service to a scope of the behavior control rules; and
forwarding a fusion computation request issued from within the fusion group to the fusion service, to respond, by utilizing the fusion service, to the fusion computation request in the trusted execution environment.

Examples of the present disclosure further provides a data fusion system, including: a control platform, a trusted device, and at least one fusion group;
the control platform is to: for a target fusion group with a fusion requirement among the at least one fusion group, send a service creation request to the trusted device; and provide behavior control rules signed and issued by each participant in the fusion group to the trusted device;
the trusted device is to: create a dedicated fusion service for the target fusion group according to the service creation request; and
the fusion service is to: respond to a fusion computation request issued from within the target fusion group, within a scope of the behavior control rules in a trusted execution environment provided by the trusted device.

Examples of the present disclosure further provides a trusted device, including: a memory, a processor, and a communication component;
where the memory is to store one or more computer instructions;
the processor is coupled to the memory and the communication component, used for executing the one or more computer instructions to:
for each of one or more fusion groups with a requirement, create a dedicated fusion service for the fusion group in a trusted execution environment;
obtain behavior control rules signed and issued by each participant in the fusion group; and
respond, by utilizing the fusion service, to a fusion computation request issued from within the fusion group, within a scope of the behavior control rules in the trusted execution environment.

Examples of the present disclosure further provides a control device, including: a memory, a processor, and a communication component;
where the memory is configured to store one or more computer instructions;
the processor is coupled to the memory and the communication component, used for executing the one or more computer instructions to:
for each of one or more fusion groups with a requirement, trigger a trusted device to create a dedicated fusion service for the fusion group, where the trusted device provides a trusted execution environment for the fusion service;
provide behavior control rules signed and issued by each participant in the fusion group to the trusted device, to limit service permissions for the fusion service to a scope of the behavior control rules; and
forward a fusion computation request issued from within the fusion group to the fusion service, to respond, by utilizing the fusion service, to the fusion computation request in the trusted execution environment.

Examples of the present disclosure further provides a computer-readable storage medium storing one or more computer instructions, and when the one or more computer instructions are executed by one or more processors, the one or more processors are caused to perform the foregoing data fusion method.

In the present disclosure, for each of one or more fusion groups with a requirement, a dedicated fusion service may be created for the fusion group in a trusted execution environment, and a behavior control rule fusion service signed and issued by each participant in the fusion group may be obtained; and based on this, in the trusted execution environment, the fusion service may be utilized to, within the scope of the behavior control rules, respond to a fusion computation request issued from within the fusion group. Accordingly, the fusion computation processes of different fusion groups may be isolated from each other based on different fusion services created for the different fusion groups, and the fusion service completely runs in a trusted execution environment, cannot be tampered with, and works in accordance with behavior control rules by default, which may completely eliminate the problem of unauthorized leakage of data of participants in the fusion computation processes, and ensure the security and/or privacy of the data.

### BRIEF DESCRIPTION OF DRAWINGS

The accompanying drawings described here are used to provide a further understanding of the present disclosure and constitute a part of the present disclosure. The schematic examples of the present disclosure and the description thereof are used to explain the present disclosure, and do not constitute an improper limitation on the present disclosure. The accompanying drawings include the following.

FIG. 1 is a schematic structural diagram of a data fusion system according to an example of the present disclosure.

FIG. 2 is a schematic interaction logic diagram of a data fusion scheme according to an example of the present disclosure.

FIG. 3 is a schematic flowchart of a data fusion method according to another example of the present disclosure.

FIG. 4 is a schematic flowchart of another data fusion method according to another example of the present disclosure.

FIG. 5 is a schematic structural diagram of a trusted device according to yet another example of the present disclosure.

FIG. 6 is a schematic structural diagram of a control device according to yet another example of the present disclosure.

### DETAILED DESCRIPTION

The technical solutions of the present disclosure will be clearly and completely described in the following in conjunction with the specific examples of the present disclosure and the accompanying drawings in order to make the purpose, technical solutions and advantages of the present disclosure clearer. It is clear that the described examples are only a part, but not all, of the examples of the present disclosure. All other examples obtained by those skilled in the art without creative effort based on the examples of the present disclosure fall within the scope of the present disclosure.

Currently, in the process of data fusion, data leakage problems of the participants often occur, which brings losses to the participants. Thus, in some examples of the present disclosure, for a fusion group with requirements, a dedicated fusion service may be created for the fusion group in a trusted execution environment, and behavior control rules signed and issued by each participant in the fusion group may be acquired; and based on this, in the trusted execution environment, the fusion service may be utilized to, within the scope of the behavior control rules, respond to a fusion computation request issued from within the fusion group. Accordingly, the fusion computation processes of different fusion groups may be isolated from each other based on different fusion services created for different fusion groups, and the fusion services completely run in a trusted execution environment, cannot be tampered with, and work in accordance with behavior control rules by default, which may completely eliminate the problem of unauthorized leakage of data of participants in the fusion computation processes, and ensure the security and/or privacy of the data.

The technical solutions provided in the examples of the present disclosure will be described in detail in the following with reference to the accompanying drawings.

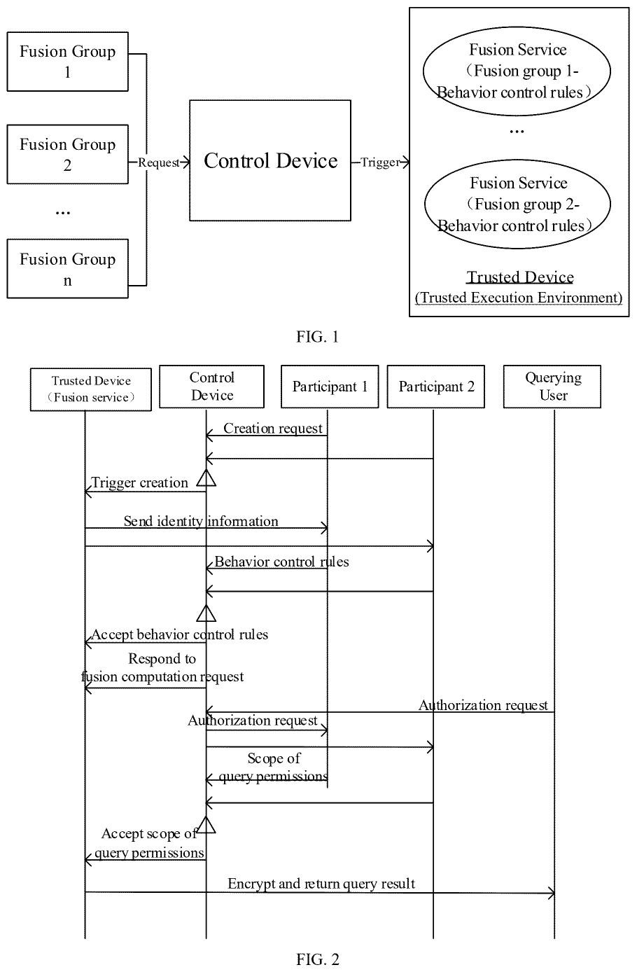

FIG. 1 is a schematic structural diagram of a data fusion system according to an example of the present disclosure. FIG. 2 is a schematic interaction logic diagram of a data fusion scheme according to an example of the present disclosure. As illustrated in FIG. 1, the system includes: a control device, a trusted device, and at least one fusion group, where a single fusion group includes a plurality of participants, and the participants are the owners of the data.

Data of participants may be held in a database, preferably, in this example, a fully encrypted database may be used to hold the data of the participants. The fully encrypted database may be understood as a database that processes data in a ciphertext form throughout the process of transmission, use, and storage, including but not limited to SQL database or Gauss database, etc. More and more participants are placing their data in the cloud, and a fully encrypted database may completely eliminate the possibility that a cloud platform as well as an operation and maintenance personnel access plaintext data, guaranteeing the participants' full ownership of their data in the cloud, and ensuring that a cloud platform cannot obtain users' plaintext data throughout the process of providing database services. Authorized users may normally read and write data in the cloud database through existing protocols, and unauthorized users may not obtain the plaintext data of protected users. Of course, the participants in this example may further organize their own data in other forms of security and cooperate with the data fusion scheme provided in this example to ensure the full link security of their data, and this example is not limited thereto.

Referring to FIG. 1 and FIG. 2, in this example, the control device may communicate with a trusted device and at least one fusion group respectively. For a fusion group with a requirement, participants in the fusion group may register in advance in the control device, and each participant in the fusion group may interact with the control device after registration. A trusted channel may be established in advance between the control device and the trusted device based on a trusted interface provided by the trusted device, and serves as a secure communication channel between the control device and the trusted device. The requirement here may refer to a requirement for data fusion.

In this example, a trusted device refers to a device that can be trusted. Trusted devices may typically implement a trusted execution environment based on TPM/TCM chips or CPU instruction sets, which is of course just an example, and this example is not limited thereto, and other types of technologies existing now or in the future may further be used to implement a trusted execution environment. The trusted device may be a physical device equipped with a trusted module such as a TPM/TCM chip, etc., or may also be a trusted virtual machine created in the cloud, which may be equipped with a virtual TPM/TCM module, and correspondingly, the underlying architecture of the trusted virtual machine may adopt a hardware architecture equipped with a trusted module such as a TPM/TCM chip, etc. For example, computing resources (including VCPU and memory) may be divided in a cloud server instance (as a host VM) to create an enclave VM (may be referred to as EVM for short) as a trusted device to provide a trusted execution environment. The security guarantee of EVM is reflected in: the underlying virtualization technology providing secure isolation, the EVM isolated from the host VM and isolated from other cloud server instances; an independent and customized trusted operating system running in the EVM, no persistent storage, interactive connections, or external network paths, only allowing communication with the host VM through a local secure channel (based on vsock or device files, etc.), which minimizes the attack surface to the greatest extent.

In addition, in this example, the quantity of trusted devices in the data fusion system may be one or more, based on this, for different fusion groups, appropriate trusted devices may be selected as needed to execute the processing logic related to the trusted devices in this example.

For ease of description, a fusion group in the at least one fusion group will be taken as an example in the following, to illustrate a scheme for performing data fusion in the fusion group, and other fusion groups may implement data fusion in the same manner.

Referring to FIG. 1 and FIG. 2, for a fusion group with a requirement, the control device may trigger the trusted device to create a dedicated fusion service for the fusion group. In this process, for the fusion group, a fusion service creation request may be initiated to the control device, and the control device may forward the fusion service creation request to the trusted device through the foregoing trusted interface, so as to trigger the trusted device to create a dedicated fusion service for the fusion group. Where the fusion service creation request may carry the identity information of each participant in the fusion group, so that the control device may collect the identity information of all participants in the fusion group, and the identity information may include, but is not limited to, names, public keys, certificates, etc., of the participants. The control device may forward the identity information of all participants in the fusion group to the trusted device. Of course, in this example, the control device may be used to coordinate and manage the fusion computation processes of each fusion group, and in addition to using the fusion service creation request, the control device may further use other manners to trigger the trusted device to create a dedicated fusion service for a fusion group, and even in some possible designs, it may not be necessary for the control device to initiate the trigger, and the trusted device autonomously starts creation processes of the fusion services for different fusion groups, which is not limited in this example.

For a trusted device, a dedicated fusion service may be created for a fusion group with a requirement. In this example, a preset code logic may run in the trusted device, and a creation operation (e.g., a create statement) may be configured in the code logic, so that when the trigger condition is met, the code logic may drive the trusted device to perform the creation operation of the fusion service, thereby creating a dedicated fusion service for a fusion group with a requirement. Following the foregoing trigger manner of the fusion service creation request forwarded by the control device, the trusted device may create a dedicated fusion service for the fusion group according to the fusion service creation request.

During the creation process, the trusted device may initialize the fusion service based on the identity information of all participants in the fusion group, to ensure the specificity of the fusion service. In some examples, the trusted device may generate identity information for the fusion service and securely provide the identity information of the fusion service to each participant in the fusion group. Where the identity information of the fusion service may include an identification (ID) and a public key, etc. In the process of providing the identity information of the fusion service to each participant, a security authentication (remote attestation) mechanism provided by a trusted execution environment (TEE) or a method based on a public key may be used to establish an end-to-end secure communication channel, and the identity information may be securely transmitted through this secure communication channel, which is not described in details here. It should be understood that, the identity information here is a part of information generated by the trusted device for the fusion service that may be provided to each participant. The information generated by the trusted device for the fusion service is not limited thereto, but includes information such as a private key of the fusion service, etc. Based on this, the trusted device may establish an association between the fusion service and the fusion group based on the identity information of the fusion service and the identity information of each participant in the fusion group. For example, a hash value corresponding to a fusion group may be calculated based on the identity information (e.g., a public key) of each participant in the fusion group, and the identification (ID) in the identity information of the fusion service created for the fusion group is associated with the hash value corresponding to the fusion group. Thus, when there are a plurality of fusion services in the trusted device, the respective dedicated fusion services for different fusion groups may be correctly found based on the association between the fusion services and the fusion groups, thereby ensuring the specificity of each fusion service. Where the specificity here means that the fusion service is dedicated to a certain fusion group and is not to be used for other fusion groups. This may effectively isolate the data between different fusion groups, which avoids mutual data access between fusion groups during the fusion computation process, thereby avoiding data leakage.

Accordingly, the trusted device may create dedicated fusion services for different fusion groups respectively. In this example, the implementation form of the fusion service may be an application, a process, an instance, etc., which is not limited in this example. The trusted device may provide a trusted execution environment for each fusion service, which ensures that the fusion service is completely black-boxed, tamper-proof during operation, and trustworthy. Therefore, the fusion service may act as a completely trusted and neutral third party to carry out trustworthy and secure fusion computation work for the fusion group.

It is worth noting that, in the process of creating the fusion service described above, the control device mainly participates in the control of related processes, but does not have the permission to access the internal data of the trusted device. Therefore, the control device cannot obtain key information of the foregoing fusion service and any intermediate data generated by the fusion service in the work process. This ensures that the data of each participant in the fusion group is not leaked to the control device during the fusion computation process. In this example, the control device does not need to be secure and trustworthy, but only needs to be able to perform relevant operations with honesty, which therefore may be easily combined with management control platforms (e.g., an enterprise OA system, a public cloud management service, etc.) in practical applications. In some examples, conventional honesty monitoring manners such as logs, audits and the like may be used to monitor the honesty of the control device, which is not limited in this example.

On the basis of ensuring the trustworthiness of the fusion service itself, referring to FIG. 1, in this example, each participant in the fusion group may further sign and issue behavior control rules and send the behavior control rules to the control device. The control device may provide the behavior control rules signed and issued by each participant in the fusion group to the trusted device. In this example, the behavior control rules signed and issued by a single participant are used to record the fusion computation behaviors that the participant allows the fusion service to perform on the data of the participant. To ensure the security of the behavior control rules during transmission, each participant in the fusion group may use their respective private keys to sign and issue behavior control rules, and as mentioned earlier, the public keys of each participant have been forwarded to the trusted device by the control device, so the trusted device may use a corresponding public key to verify the signature of each participant on the behavior control rules.

Based on this, the trusted device may obtain the behavior control rules signed and issued by each participant in the fusion group. The behavior control rules may be used to record the fusion service authorized by the participant and the behavior operations the participant allowed the fusion service to perform, and the behavior operations may include, but are not limited to, accessing data, performing specified types of computation logic with specified participants in the current fusion group, etc. Here, the types of computation logic are diverse, e.g., addition, subtraction, multiplication, division, comparison, text computation, sorting, etc., which are not exhaustive here. The participant may specify the authorized fusion service by recording the identity information (e.g., the foregoing identification (ID) and/or public key) of the fusion service in the behavior control rules, and the identity information may be used to uniquely represent the corresponding fusion service. In this example, the behavior control rules signed and issued by different participants in the fusion group may not be exactly the same. In this example, each participant in the fusion group may sign and issue behavior control rules locally without relying on third parties, which ensures that the signing and issuing process of behavior control rules is carried out in a controllable environment of the participant, avoiding security problems with the use of the participant's private key.

In this example, during the foregoing creation process of the fusion service, the trusted device may create a dedicated fusion service with full-service capability for a fusion group, and limit the service permissions available for the fusion service based on the behavior control rules signed and issued by each participant in the fusion group. Of course, this example is not limited thereto, and the trusted device may further create a dedicated fusion service with limited service capability for the fusion group based on the behavior control rules. In either way, the dedicated fusion service created for the fusion group may provide services strictly within the scope of the behavior control rules corresponding to the fusion group.

In an implementation, the trusted device may perform a verification of the behavior control rules signed and issued by each participant in the fusion group by utilizing the fusion service; if the verification is successful, the trusted device may control the fusion service to accept the behavior control rules, so as to limit service permissions for the fusion service within the scope of the behavior control rules. In the implementation, it is proposed that the verification of behavior control rules is performed in the viewpoint of the fusion service. In this way, on the one hand, each participant in the fusion group may limit the corresponding fusion service and the service permissions of the fusion service by signing and issuing behavior control rules; on the other hand, the fusion service may reversely verify the validity of the received behavior control rules and accept the received behavior control rules only when it is determined that the received behavior control rules are valid. Through this two-way limiting implementation, malicious issuance of behavior control rules may be effectively avoided, ensuring that the service permissions of the fusion service truly match with the behavior control rules of each participant in the fusion group, which avoids unauthorized behaviors.

In the implementation, the verification process for the behavior control rules by the fusion service may include: verifying whether the behavior control rules are signed and issued by the corresponding participant; and verifying whether the behavior control rules signed and issued by all participants in the fusion group have been received. In this way, the fusion service may verify whether the behavior control rules are signed and issued by an imposter and verify the integrity. In actual applications, participants may use their own private keys to sign and issue behavior control rules, and as mentioned earlier, the fusion service has learned the identity information of each participant in the fusion group, including the public keys of the participants, so the fusion service may use the public keys of the participants to verify whether the behavior control rules are signed and issued by an imposter and verify the integrity. This may ensure that the behavior control rules followed by the fusion computation truly conform to the real expectations of the participants. The fusion service may further verify the comprehensiveness of the received behavior control rules. The control device may synchronize the quantity of participants included in the fusion group and identity information, etc., to the fusion service, and based on this, the fusion service may verify the comprehensiveness of the received behavior control rules. This may ensure the comprehensiveness of the behavior control rules followed by the fusion service, and avoid unauthorized behaviors of the fusion service due to a lack of behavior control rules of one or more participants which further leading to the problem of a leakage of data of the participants lacking the behavior control rules.

Further, in the implementation, if it is determined that the behavior control rules signed and issued by each participant in the fusion group passes the verification, the trusted device may control the fusion service to sign the behavior control rules; and store the signed behavior control rules as the basis for limiting service permissions in subsequent responses to fusion computation requests. The fusion service may use its own private key to sign the verified behavior control rules. Here, the signing operation of the behavior control rules by the fusion service, on the one hand, may indicate to the trusted device that the behavior control rules corresponding to the current fusion group have taken effect, in this way, the trusted device does not need to control the fusion service to verify these behavior control rules again afterwards; on the other hand, the fusion service itself may be prompted that it has completed verification of these behavior control rules and may directly follow these behavior control rules afterwards. Instead, if the trusted device determines that there is a behavior control rule for the fusion group that does not pass the verification, it may refuse to accept the behavior control rules related to the fusion group. In some examples, the trusted device may return an exception notice to each participant in the fusion group to prompt each participant that a data security event has occurred, thereby ensuring the data security of each participant.

In this example, the fusion service accepting the behavior control rules signed and issued by each participant in the fusion group means that the fusion service is to provide services strictly within the scope limited by these behavior control rules. Since the fusion service runs in a trusted execution environment, as long as such execution logic is preset in the code logic of the fusion service, it may be ensured that the fusion service can indeed provide services within the scope limited by these behavior control rules.

Based on this, referring to FIG. 1, the trusted device may utilize the fusion service to respond to a fusion computation request issued from the fusion group within the scope of the behavior control rules in the trusted execution environment.

After completing the foregoing creation of the fusion service and the service permission configuration, the fusion service may provide dedicated services for the fusion group. A fusion computation request may be issued from within the fusion group, which may come from a part or all of the participants in the fusion group, and the fusion computation request may include a required fusion computation behavior, and the fusion computation behavior may specify at least one involved target participant and a type of required computation logic. The fusion group may issue a fusion computation request to the control device, which may forward the fusion computation request to the trusted device. For the trusted device, after receiving the fusion computation request issued from within the fusion group, it may determine a dedicated fusion service for the fusion group and judge whether the fusion computation behavior indicated in the fusion computation request is within the scope of the behavior control rules corresponding to the fusion group; if yes, the dedicated fusion service for the fusion group may be used to respond to the fusion computation request.

One scheme for judging whether the fusion computation behavior indicated in the fusion computation request is within the scope of the behavior control rules corresponding to the fusion group may be: parsing out at least one target participant involved in the fusion computation behavior indicated in the fusion computation request; in response to determining that the fusion computation behavior conforms to behavior control rules signed and issued by all target participants, determining that the fusion computation behavior is within the scope of the behavior control rules. That is, if all the target participants' behavior control rules allow the fusion service to perform the fusion computation behavior indicated in the fusion computation request, then it is determined that the fusion computation behavior is within the scope of the behavior control rules. For example, if a fusion group includes three participants A, B, and C, and participant A initiates a fusion computation request and expects to perform addition computation (i.e., the fusion computation behavior) with participant B, then the trusted device may: first parse out the two target participants involved in the fusion computation request, i.e., A and B, then query whether the behavior control rules signed and issued by participant A allow the fusion service to perform addition computation, and query whether the behavior control rules signed and issued by participant B allow the fusion service to perform addition computation. If the query results for the behavior control rules of participant A and participant B are both yes, it may be determined that the fusion computation behavior indicated in the fusion computation request is within the scope of the behavior control rules, and the fusion service may access data of participants A and B and perform addition computation on the data of both parties.

After the fusion service responds to the fusion computation request, a fusion computation result may be generated. For a fusion group, participants within the fusion group may initiate fusion computation requests a plurality of times, and the fusion service may store the fusion computation results generated by a plurality of fusion computation requests, for example, by building a set of fusion computation results corresponding to the fusion group. In this way, for a repeated fusion computation request, the fusion computation operation does not need to be repeatedly executed. Fusion computation results may only be accessed by the fusion service itself or forwarded to querying users after authorization and encryption.

Accordingly, in the example of the present disclosure, for a fusion group with a requirement, a dedicated fusion service may be created for the fusion group in a trusted execution environment, and behavior control rules signed and issued by each participant in the fusion group may be obtained; and based on this, in the trusted execution environment, the fusion service may be utilized to, within the scope of the behavior control rules, respond to a fusion computation request issued from within the fusion group. Accordingly, fusion computation processes of different fusion groups may be isolated from each other based on different fusion services created for the different fusion groups, and the fusion service completely runs in a trusted execution environment, cannot be tampered with, and works in accordance with behavior control rules by default, which may completely eliminate the problem of unauthorized leakage of data of participants in the fusion computation processes, and ensure the security and/or privacy of the data.

In the foregoing or following examples, the fusion service may further be used to provide query services for fusion computation results.

Referring to FIG. 2, in this example, for a querying user who needs to query the fusion computation result of the fusion group, a scope of query permissions may be configured in advance for the querying user. Thus, in this example, the control device may send an authorization request to each participant in the fusion group for the querying user. Each participant in the fusion group may locally sign and issue a scope of query permissions for the querying user, and send the scope of query permissions to the control device. The scope of query permissions may be used to record a querying user authorized by the participant and limitation information of query permissions for the authorized querying user. The limitation information may include, but is not limited to: a specification of a query result, an identifier of a fusion computation result allowed for querying, an encryption key, and/or a number of queries, etc. The control device may receive the scopes of query permissions signed and issued by each participant in the fusion group for the querying user, and provide the scopes of query permissions to the trusted device. The trusted device may limit query services provided by the fusion service for the querying user to the scopes of query permissions. In this way, the trusted device may limit the query services provided by the dedicated fusion service for the fusion group to different querying users within the respective scopes of query permissions, ensuring that the dedicated fusion service of the fusion group provides query services strictly in accordance with the scopes of query permissions designated by each participant in the fusion group, which avoids unauthorized queries.

In this example, the trusted device may perform the configuration of the scope of query permissions by the same scheme as that for the foregoing configuration of behavior control rules. Here is only a brief description: the trusted device may use the fusion service to, perform a verification of the scopes of query permissions signed and issued by each participant in the fusion group for the querying user; and if the verification is successful, the trusted device controls the fusion service to accept the scopes of query permissions, to limit the query services provided by the fusion service for the querying user to the scopes of query permissions. The verification process of the scopes of query permissions by the fusion service may include: verifying whether the scopes of query permissions are signed and issued by the corresponding participants; and verifying whether the scopes of query permissions signed and issued by all participants in the fusion group have been received. Specific details may refer to the foregoing configuration process of the behavior control rules, which is not described in details here. Similarly, in a case that the scopes of query permissions pass the verification, the fusion service may further sign and persistently store the scopes of query permissions.

Based on this, the control device may receive a query request for a fusion computation result of the fusion group initiated by a querying user, and may forward the query request to the trusted device. For a trusted device, a dedicated fusion service for a fusion group may be controlled to process the query request. The trusted device may use the dedicated fusion service for the fusion group to judge whether the current query request conforms to the scopes of query permissions signed and issued in advance by each participant in the fusion group for the current querying user, and if so, a query result extracted from the fusion computation result may be encrypt and output to the querying user. In some examples, the scopes of query permissions may further specify the encryption key used by the querying user, and the fusion service may encrypt the query result according to the encryption key specified in the scope of query permissions, and provide the encrypted query result to the querying user. For example, the encryption key specified in the scope of query permissions may be any one of a plurality of data encryption keys (DEKs, used by the user to encrypt data) owned by the querying user.

Accordingly, in this example, each participant in the fusion group may sign and issue a scope of query permissions for different querying users, respectively, thereby limiting the query services of the dedicated fusion service to the scope of query permissions. In this way, the security protection of the fusion computation results may be implemented, avoiding unauthorized disclosure of the fusion computation results.

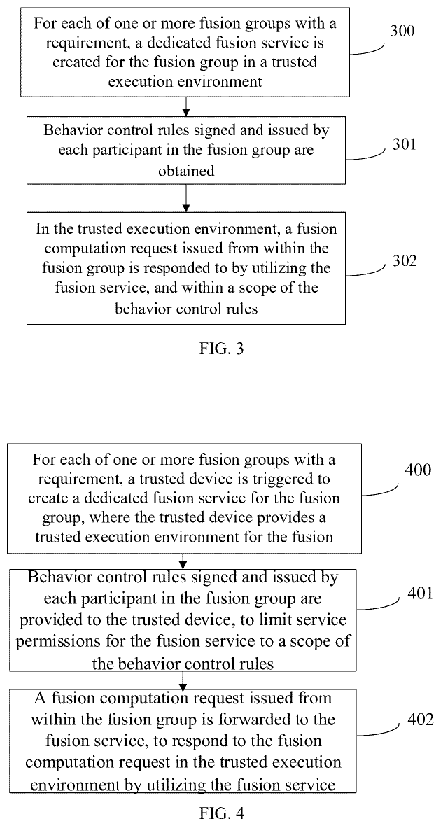

FIG. 3 is a schematic flowchart of a data fusion method according to another example of the present disclosure. The method may be executed by a data processing apparatus, which may be implemented as a combination of software and/or hardware, and may be integrated into the trusted device in the foregoing system examples. Referring to FIG. 3, the method includes the following.

In process 300, for each of one or more fusion groups with a requirement, a dedicated fusion service is created for the fusion group in a trusted execution environment.

In process 301, behavior control rules signed and issued by each participant in the fusion group are obtained.

In process 302, in the trusted execution environment, a fusion computation request issued from within the fusion group is responded to by utilizing the fusion service, within a scope of the behavior control rules.

In an example, the method further includes the following.

The behavior control rules signed and issued by each participant in the fusion group are verified by utilizing the fusion service.

In response to the verification being successful, the fusion service is controlled to accept the behavior control rules, to limit service permissions for the fusion service to the scope of the behavior control rules.

In an example, the verification process for the behavior control rules includes the following.

Whether each of the behavior control rules is signed and issued by the participant corresponding to the behavior control rule is verified.

Whether the behavior control rules signed and issued by all participants in the fusion group have been received is verified.

In an example, the process of controlling the fusion service to accept the behavior control rules includes the following.

The fusion service is controlled to sign the behavior control rules.

The signed behavior control rules are stored as a basis for limiting service permissions in a subsequent process of responding to a fusion computation request.

In an example, the process of responding to a fusion computation request issued from within the fusion group within a scope of the behavior control rules, includes the following.

The fusion computation request issued from within the fusion group is received.

In response to determining that a fusion computation behavior indicated in the fusion computation request is within the scope of the behavior control rules, the fusion computation request is responded to.

In an example, the method further includes the following.

At least one target participant involved in the fusion computation behavior indicated in the fusion computation request is parsed out.

In response to determining that the fusion computation behavior conforms to the behavior control rules signed and issued by all target participants, it is determined that the fusion computation behavior is within the scope of the behavior control rules.

In an example, the method further includes the following.

A query request for a fusion computation result of the fusion group initiated by a querying user is received.

In response to determining that the query request conforms to a scope of query permissions signed and issued in advance by each participant in the fusion group for the querying user, a query result extracted from the fusion computation result is encrypted and output to the querying user.

In an example, the scope of query permissions includes: a specification of a query result, an identifier of a fusion computation result allowed for query, and/or a number of queries.

It is worth noting that, the technical details in the foregoing examples of the data fusion method may refer to the related descriptions of the trusted device in the foregoing system examples, and in order to save space, details are not described here again, which should not result in a loss of the scope of protection of the present disclosure.

FIG. 4 is a schematic flowchart of another data fusion method according to another example of the present disclosure. The method may be executed by a data processing apparatus, which may be implemented as a combination of software and/or hardware, and may be integrated into the control device in the foregoing system examples. Referring to FIG. 4, the method includes the following.

In process 400, for each of one or more fusion groups with a requirement, a trusted device is triggered to create a dedicated fusion service for the fusion group, where the trusted device provides a trusted execution environment for the fusion service.

In process 401, behavior control rules signed and issued by each participant in the fusion group are provided to the trusted device, to limit service permissions for the fusion service to a scope of the behavior control rules.

In process 402, a fusion computation request issued from within the fusion group is forwarded to the fusion service, to respond to the fusion computation request in the trusted execution environment by utilizing the fusion service.

In an example, the method further includes the following.

For a querying user who needs to query a fusion computation result of the fusion group, an authorization request is sent to each participant in the fusion group.

Scopes of query permissions signed and issued by each participant in the fusion group for the querying user are received.

The scopes of query permissions are provided to the trusted device, to allow the trusted device to limit a query service provided by the fusion service for the querying user to the scopes of query permissions.

In an example, the method further includes the following.

A query request for a fusion computation result of the fusion group initiated by a querying user is received.

The query request is forwarded to the trusted device, to allow the trusted device to: determine whether the query request conforms to the scopes of query permissions by utilizing the fusion service; and if yes, encrypt and output a query result extracted from the fusion computation result to the querying user.

It is worth noting that, the technical details in the foregoing examples of the data fusion method may refer to the related descriptions of the trusted device in the foregoing system examples, and in order to save space, details are not described here again, which should not result in a loss of the scope of protection of the present disclosure.

It should be noted that the execution subject of all processes of the method provided in the implementations of the present disclosure may be the same device, or the method may also use different devices as execution subjects. In some of the processes described in the foregoing examples and accompany drawings, there are a plurality of operations that appear in a specific order, but it should be clear that these operations may be executed in parallel or not in the order they appear in the present disclosure, and the operation numbers such as 300, 301, etc., are merely used to distinguish different operations, and the numbers themselves do not represent any execution order.

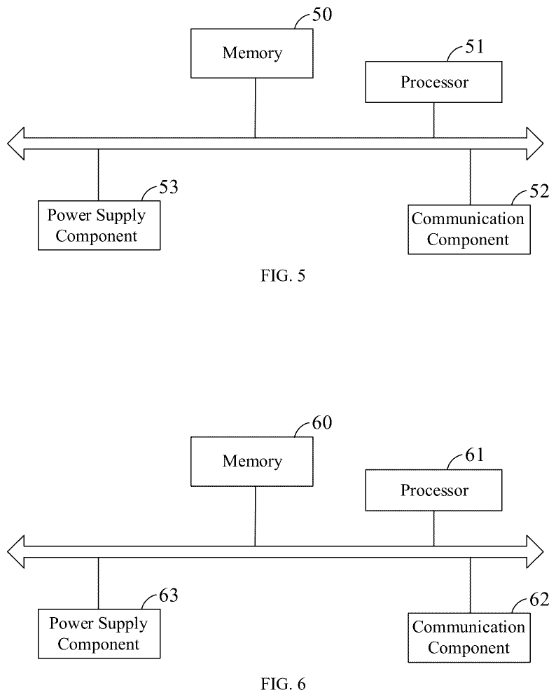

FIG. 5 is a schematic structural diagram of a trusted device according to another example of the present disclosure. As illustrated in FIG. 5, the computing device includes: a memory 50, a processor 51, and a communication component 52.

The processor 51 is coupled to the memory 50 and the communication component 52, used for executing the one or more computer instructions to:
for each of one or more fusion groups with a requirement, create a dedicated fusion service for the fusion group in a trusted execution environment;
obtain behavior control rules signed and issued by each participant in the fusion group; and
respond, by utilizing the fusion service, to a fusion computation request issued from within the fusion group, within a scope of the behavior control rules in the trusted execution environment.

In an example, the processor 51 may receive, through the communication component 52, a fusion service creation request issued from within the fusion group and forwarded by the control device, to start the operation of creating a dedicated fusion service for the fusion group in the trusted execution environment.

In an example, the processor 51 may be further used to:
perform, by utilizing the fusion service, a verification of the behavior control rules signed and issued by each participant in the fusion group; and
in response to the verification being successful, control the fusion service to accept the behavior control rules, to limit service permissions for the fusion service to the scope of the behavior control rules.

In an example, the processor 51 may, in the verification process for the behavior control rules, be further used to:
verify whether each of the behavior control rules is signed and issued by the participant corresponding to the behavior control rule; and
verify whether the behavior control rules signed and issued by all participants in the fusion group have been received.

In an example, the processor 51 may, in the process of controlling the fusion service to accept the behavior control rules, be further used to:
control the fusion service to sign the behavior control rules; and
store the signed behavior control rules as a basis for limiting service permissions in a subsequent process of responding to a fusion computation request.

In an example, in the process of responding to a fusion computation request issued from within the fusion group, within the scope of the behavior control rules, the processor 51 may be used to:
receive the fusion computation request issued from within the fusion group; and
in response to determining that a fusion computation behavior indicated in the fusion computation request is within the scope of the behavior control rules, respond to the fusion computation request.

In an example, the processor 51 may be further used to:
parse out at least one target participant involved in the fusion computation behavior indicated in the fusion computation request; and
in response to that the fusion computation behavior conforms to behavior control rules signed and issued by all of the at least one target participants, determine that the fusion computation behavior is within the scope of the behavior control rules.

In an example, the processor 51 may be further used to:
receive a query request for a fusion computation result of the fusion group initiated by a querying user; and
in response to that the query request conforms to a scope of query permissions signed and issued in advance by each participant in the fusion group for the querying user, encrypt and output a query result extracted from the fusion computation result to the querying user.

In an example, the scopes of query permissions include: a specification of the query result, an identifier of a fusion computation result allowed for query, and/or a number of queries.

Further, as illustrated in FIG. 5, the trusted device further includes other components such as a power supply component 53. FIG. 5 only schematically illustrates some components, which does not mean that the trusted device only includes the components illustrated in FIG. 5.

It is worth noting that, the technical details in the foregoing examples of the data fusion method may refer to the related descriptions of the trusted device in the foregoing system examples, and in order to save space, details are not described here again, which should not result in a loss of the scope of protection of the present disclosure.

FIG. 6 is a schematic structural diagram of a control device according to another example of the present disclosure. As illustrated in FIG. 6, the computing device includes: a memory 60, a processor 61, and a communication component 62.

The processor 61 is coupled to the memory 60 and the communication component 62, used for executing the one or more computer instructions to:
for each of one or more fusion groups with a requirement, trigger a trusted device to create a dedicated fusion service for the fusion group, where the trusted device provides a trusted execution environment for the fusion service;
provide behavior control rules signed and issued by each participant in the fusion group to the trusted device, to limit service permissions for the fusion service to a scope of the behavior control rules; and
forward a fusion computation request issued from within the fusion group to the fusion service, to respond to, by utilizing the fusion service, the fusion computation request in the trusted execution environment.

In an example, the processor 61 may forward, through the communication component 62, a fusion service creation request issued from within the fusion group, to the trusted device, to trigger a dedicated fusion service created by the trusted device for the fusion group.

In an example, the processor 61 may be further used to:
for a querying user needing to query a fusion computation result of the fusion group, send an authorization request to each participant in the fusion group;
receive a scope of query permissions signed and issued by each participant in the fusion group for the querying user; and
provide the scopes of query permissions to the trusted device, to allow the trusted device to limit a query service provided by the fusion service for the querying user to the scopes of query permissions.

In an example, the processor 61 may be further used to:
receive a query request for a fusion computation result of the fusion group initiated by a querying user; and
forward the query request to the trusted device, to allow the trusted device to: determine whether the query request conforms to the scopes of query permissions by utilizing the fusion service; and in responding to the query request conforming to the scopes of query permissions, encrypt and output a query result extracted from the fusion computation result to the querying user.

Further, as illustrated in FIG. 6, the control device further includes other components such as a power supply component 63. FIG. 6 only schematically illustrates some components, which does not mean that the trusted device only includes the components illustrated in FIG. 6.

It is worth noting that, the technical details in the foregoing examples of the data fusion method may refer to the related descriptions of the trusted device in the foregoing system examples, and in order to save space, details are not described here again, which should not result in a loss of the scope of protection of the present disclosure.

Accordingly, examples of the present disclosure provide a computer-readable storage medium storing a computer program, when the computer program is executed by a processor, each process executed by a trusted device/control device in the above method examples can be implemented.

The foregoing memories in FIG. 5 and FIG. 6 are used to store computer programs and may be configured to store other various data to support operations on a computing platform. Examples of such data include instructions of any applications or methods operating on the computing platform, contact data, phone book data, messages, images, videos, etc. The memory may be implemented by any type of volatile or non-volatile storage devices or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The communication component in FIG. 5 and FIG. 6 is configured to facilitate wired or wireless communication between the device on which the communication component is located and other devices. The device with the communication component may access wireless networks based on communication standards, such as WiFi, 2G, 3G, 4G/LTE, 5G, or a combination thereof. In an example, the communication component receives a broadcast signal or broadcast related information from an external broadcast management system via a broadcast channel. In an example, the communication component may also include a near field communication (NFC) module to facilitate short-range communications. For example, the NFC module may be implemented based on a radio frequency identification (RFID) technology, an Infrared Data Association (IrDA) technology, an ultra wideband (UWB) technology, a bluetooth (BT) technology and other technologies.

The power supply component 63 in FIG. 5 and FIG. 6 provides power to various assemblies on the device where the power supply component is located. The power supply component may include a power supply management system, one or more power supplies and other assemblies associated with generating, managing and distributing power for the device where the power supply component is located.

Those skilled in the art should understand that, the implementations of the present disclosure may be provided as a method, a system, or a computer program product. Therefore, the present disclosure may take the form of an entirely hardware implementation, an entirely software implementation, or an implementation combining both software and hardware aspects. Moreover, the present disclosure may take the form of a computer program product implemented on one or more computer-usable storage media (including, but not limited to, disk memory, CD-ROM, optical memory, etc.) containing computer-usable program code.

The examples of the present disclosure are described with reference to flowcharts and/or block diagrams of the method, device (system), and the computer program product in the examples of this application. It should be understood that, each process and/or block in the flowcharts and/or block diagrams as well as combinations of processes and/or blocks in the flowcharts and/or block diagrams may be implemented by computer program instructions. These computer program instructions may be provided to a processor of a general-purpose computer, a special purpose computer, an embedded processor or other programmable data processing device to generate a machine, such that the instructions executed by the processor of a computer or other programmable data processing device produce a device for achieving the functions specified in a flow chart or processes or processes and/or block diagram of one box or more boxes.

These computer program instructions may also be stored in computer-readable memory capable of booting a computer or other programmable data processing device to work in a particular manner, such that the instructions stored in the computer-readable memory produce manufactured products including an instruction device, the instruction device implements the function specified in a flow chart one or more processes and/or block diagram one box or more boxes.

These computer program instructions may also be loaded into a computer or other programmable data processing device, such that a series of operational processes are performed on a computer or other programmable device to produce computer-implemented processing, so that the instructions executed on a computer or other programmable device provide processes for achieving the functions specified in a flowchart one or more processes and/or block diagram one box or more boxes.

In a typical configuration, a computing device includes one or more processors (CPUs), input/output interfaces, network interfaces, and memories.

The memory may include a non-permanent memory, a random access memory (RAM), and/or a non-volatile memory in a computer-readable medium, such as a read-only memory (ROM) or a flash RAM. Memory is an example of the computer readable medium.

Computer-readable medium includes permanent and non-permanent, removable and non-removable media, and may accomplish information storage by any method or technology. The information may be computer readable instructions, data structures, modules of programs, or other data. Examples of computer storage media include, but are not limited to, phase change memory (PRAM), static random access memory (SRAM), dynamic random access memory (DRAM), other types of random access memory (RAM), and read-only memory (ROM), electrically erasable programmable read-only memory (EEPROM), flash memory or other memory technology, read-only disc read-only memory (CD-ROM), digital versatile disc (DVD) or other optical storage, magnetic tape cartridges, magnetic tape storage or other magnetic storage devices or any other non-transmitting medium, which can be used to store information that can be accessed by a computing device. As defined herein, the computer-readable medium does not include temporary computer-readable media (transitory media), e.g., modulated data signals and carrier waves.

It should also be noted that the terms “including”, “comprising” or any other variants are intended to cover non-exclusive inclusion, so that a process, a method, a product or a device that includes a series of elements includes not only those elements, but also includes other elements that are not explicitly listed, or elements that are inherent to such process, method, product, or device. Without more restrictions, the elements defined by the sentence “including (comprising) a/an . . . ” do not exclude the existence of other identical elements in the process, method, article or apparatus that include the elements.

The above are only implementations of the present disclosure and are not intended to limit the present disclosure. For those skilled in the art, this disclosure may have various modifications and changes. Any modification, equivalent replacement, and improvement made within the spirit and principle of this disclosure shall be all included in the scope of claims of the present disclosure.

1. A data fusion method, comprising:
for each of one or more fusion groups, creating a dedicated fusion service for the fusion group in a trusted execution environment;
obtaining behavior control rules signed and issued by each participant in the fusion group; and
responding, by utilizing the fusion service, to a fusion computation request issued from within the fusion group, within a scope of the behavior control rules in the trusted execution environment.

2. The method according to claim 1, further comprising:
performing, by utilizing the fusion service, a verification of the behavior control rules signed and issued by each participant in the fusion group; and
in response to the verification being successful, controlling the fusion service to accept the behavior control rules, to limit service permissions for the fusion service to the scope of the behavior control rules.

3. The method according to claim 2, a verification process for the behavior control rules comprising:
verifying whether each of the behavior control rules is signed and issued by the participant corresponding to the behavior control rule; and
verifying whether the behavior control rules signed and issued by all participants in the fusion group have been received.

4. The method according to claim 2, controlling the fusion service to accept the behavior control rules comprising:
controlling the fusion service to sign the behavior control rules; and
storing the signed behavior control rules as a basis for limiting service permissions in a subsequent process of responding to a fusion computation request.

5. The method according to claim 1, responding, by utilizing the fusion service, to the fusion computation request issued from within the fusion group within the scope of the behavior control rules, comprising:
receiving the fusion computation request issued from within the fusion group; and
in response to determining that a fusion computation behavior indicated in the fusion computation request is within the scope of the behavior control rules, responding to the fusion computation request.

6. The method according to claim 5, further comprising:
parsing out at least one target participant involved in the fusion computation behavior indicated in the fusion computation request; and
in response to that the fusion computation behavior conforms to behavior control rules signed and issued by all of the at least one target participant, determining that the fusion computation behavior is within the scope of the behavior control rules.

7. The method according to claim 1, further comprising:
receiving a query request for a fusion computation result of the fusion group initiated by a querying user; and
in response to that the query request conforms to a scope of query permissions signed and issued in advance by each participant in the fusion group for the querying user, encrypting and outputting a query result extracted from the fusion computation result to the querying user.

8. The method according to claim 7, wherein the scope of query permissions comprises: a specification of the query result, an identifier of a fusion computation result allowed for query, and/or a number of queries.

9. A data fusion method, comprising:
for each of one or more fusion groups, triggering a trusted device to create a dedicated fusion service for the fusion group, wherein the trusted device provides a trusted execution environment for the fusion service;
providing behavior control rules signed and issued by each participant in the fusion group to the trusted device, to limit service permissions for the fusion service to a scope of the behavior control rules; and
forwarding a fusion computation request issued from within the fusion group to the fusion service, to respond, by utilizing the fusion service, to the fusion computation request in the trusted execution environment.

10. The method according to claim 9, further comprising:
for a querying user needing to query a fusion computation result of the fusion group, sending an authorization request to each participant in the fusion group;
receiving a scope of query permissions signed and issued by each participant in the fusion group for the querying user; and
providing the scopes of query permissions to the trusted device, to allow the trusted device to limit a query service provided by the fusion service for the querying user to the scopes of query permissions.

11. The method according to claim 10, further comprising:
receiving a query request for the fusion computation result of the fusion group initiated by the querying user; and
forwarding the query request to the trusted device, to allow the trusted device to: determine whether the query request conforms to the scopes of query permissions by utilizing the fusion service; and in responding to the query request conforming to the scopes of query permissions, encrypt and output a query result extracted from the fusion computation result to the querying user.

12. A data fusion system, comprising: a control platform, a trusted device, and at least one fusion group;
wherein the control platform is to: for a target fusion group with a fusion requirement among the at least one fusion group, send a service creation request to the trusted device; and provide behavior control rules signed and issued by each participant in the fusion group to the trusted device;
the trusted device is to: create a dedicated fusion service for the target fusion group according to the service creation request; and
the fusion service is to: respond to a fusion computation request issued from within the target fusion group, within a scope of the behavior control rules in a trusted execution environment provided by the trusted device.

13. A trusted device, comprising: a memory, a processor, and a communication component;
wherein the memory is to store one or more computer instructions;
the processor is coupled to the memory and the communication component, used for executing the one or more computer instructions to perform the data fusion method according to claim 1.

14. A control device, comprising: a memory, a processor, and a communication component;
wherein the memory is to store one or more computer instructions;
the processor is coupled to the memory and the communication component, used for executing the one or more computer instructions to perform the data fusion method according to claim 9.

15. A non-transitory computer-readable storage medium storing one or more computer instructions, wherein when the one or more computer instructions are executed by one or more processors, the one or more processors are caused to perform the data fusion method according to claim 1.
